(19) United States
(12) Patent Application Publication
(10) Pub. No.: US 2003/0108584 A1
(43) Pub. Date: Jun. 12, 2003

(54) Method for producing wax premixes

(76) Inventors: Uwe Priesnitz, Solingen (DE); Peter Happe, Solingen (DE)

Correspondence Address: BAYER CROPSCIENCE LP, 100 BAYER ROAD, PITTSBURGH, PA, 15205, US

(21) Appl. No.: 10/257,182

(22) PCT Filed: Apr. 5, 2001
(86) PCT No.: PCT/EP01/03866

(30) Foreign Application Priority Data
Apr. 13, 2000 (DE) 10018396.4

(51) Int. Cl. A01N 25/00

(52) U.S. Cl. 424/405; 504/358

(57) ABSTRACT

Wax premixes containing agrochemical active substances can be prepared by a novel method by adding finely divided wax, in a mixer containing a sharp-edged mixing device, to a finely divided mixture of

at least one solid agrochemical active substance and

at least one vegetable or mineral oil

at a high stirring speed, the temperature in the mixer being below the melting point of the wax employed,

and, if appropriate, subsequently adding further additives to the product obtained.

The present application relates to a novel process for the preparation of wax premixes comprising agrochemical active substances.

When agrochemical active substances are applied in the form of granules in aquatic cultures, for example in paddy fields, there is frequently the danger that the granule particles sink down from the water surface and that the active substance is dissolved out and is present at that location at an undesirably high concentration. To avoid such unduly high local dosages, floating granules which release the active substances present from the water surface at the concentration required in each case have already been proposed (cf. JP-A 88-35 504 and JP-A 93-155 703). Thus, it has already been disclosed to prepare such floating granules by treating agrochemical active substances with a wax melt, then cooling the material, comminuting the solid product obtained, mixing the comminuted product with customary additives and then applying the mixture to suitable carrier materials. The disadvantage of this method is that the wax premix obtained after the melt has cooled is difficult to comminute and that, after the grinding process, the active substance particles are not completely enveloped by a wax coat.

It has now been found that wax premixes containing agrochemical active substances can be prepared by a novel method by adding finely divided wax, in a mixer containing a sharp-edged mixing device, to a finely divided mixture of

at least one solid agrochemical active substance and

at least one vegetable or mineral oil

at a high stirring speed, the temperature in the mixer being below the melting point of the wax employed, and,

if appropriate, subsequently adding further additives to the product obtained.

It must be considered as extremely surprising that carrying out the process according to the invention does not give rise to a physical mixture of the components employed, but that the active substance particles are enveloped by a continuous wax coating. Above all, it is unexpected that such wax premixes are only obtained by the process according to the invention when the stirring devices in the mixer are sharp-edged.

The process according to the invention is distinguished by a series of advantages. Thus, the components required are readily available, even in larger quantities. Furthermore, the process can be carried out in customary apparatuses as a fairly simple procedure. Moreover, the wax premixes obtained can be processed directly; grinding procedures are not required.

When carrying out the process according to the invention, suitable agrochemical active substances are all those active substances suitable for plant treatment which have a melting point of above 40° C. Agrochemical active substances are to be understood as meaning, in the present context, fungicides, bactericides, insecticides, acaricides, nematicides, herbicides and plant growth regulators.

Examples of fungicides which may be mentioned are: 2-anilino-4-methyl-6-cyclopropylpyrimidine; 2′,6′-dibromo-2-methyl-4′-trifluoromethoxy-4′-trifluoromethyl-1,3-thiazole-5-carboxanilide; 2,6-dichloro-N-(4-trifluoromethylbenzyl)benzamide; (E)-2-methoximino-N-methyl-2-(2-phenoxyphenyl)-acetamide; aldimorph, anilazin, azaconazole, azoxystrobin, benalaxyl, benomyl, bitertanol, blasticidin-S, bromuconazole, bupirimate, carbendazim, carboxin, quinomethionate, chlorothalonil, cymoxanil, cyproconazole, carpropamid, dichlorophen, diclobutrazole, dichlofluanid, dicloran, diethofencarb, difenoconazole, dimethirimol, dimethomorph, diniconazole, dithianon, dodine, drazoxolon, epoxyconazole, ethirimol, etridiazole, fenarimol, fenbuconazole, fenhexamide, fenitropan, fenpiclonil, fenpropidin, fenpropimorph, fluazinam, fludioxonil, fluquinconazole, flusilazole, flusulfamide, flutolanil, flutriafol, fosetyl-aluminum, fhthalide, fuberidazole, furalaxyl, guazatine, hexaconazole, hymexazole, imazalil, imibenconazole, iminoctadine, iprobenfos (IBP), iprodione, isoprothiolane, iprovalicarb, kresoxim-methyl, mepanipyrim, mepronil, metalaxyl, metconazole, methasulfocarb, methfuroxam, metiram, myclobutanil, nuarimol, ofurace, oxadixyl, oxycarboxin, penconazole, pencycuron, probenazole, prochloraz, procymidon, propiconazole, propineb, pyrifenox, pyrimethanil, quintozene (PCNB), quinoxyfen, spiroxamine, tebuconazole, tecloftalam, tecnazene, tetraconazole, thiabendazol, thicyofen, thiophanate-methyl, thiram, tolylfluanid, triadimefon, triadimenol, triazoxide, trichlamide, tricyclazole, tridemorph, triflumizole, triforine, triticonazole, trifloxystrobin, validamycin A, vinclozolin, zineb, ziram, 2-[2-(1-chlorocyclopropyl)-3-(2-chlorophenyl)-2-hydroxypropyl]-2,4-dihydro-[1,2,4]-triazole-3-thione and 1-(3,5-dimethylisoxazole-4-sulfonyl)-2-chloro-6,6-difluoro-[1,3]-dioxolo-[4,5-f]-benzimidazole

Examples of bactericides which may be mentioned are: bronopol, dichlorophen, nitrapyrin, octhilinone, oxytetracyclin, probenazole, streptomycin and tecloftalam.

Examples of insecticides, acaricides and nematicides which may be mentioned are: abamectin, alanycarb, aldicarb, amitraz, avermectin, AZ 60541, azocyclotin, 4-bromo-2-(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bufencarb, buprofezin, butocarboxin, butylpyridaben, carbaryl, carbofuran, chlorofluazuron, N-[(6-chloro-3-pyridinyl)-methyl]-N′-cyano-N-methylethanimidamide, clofentezine, cyromazine, diafenthiuron, diazinon, dichlofenthion, diethion, diflubenzuron, dimethoate, dioxathion, disulfoton, emamectin, esfenvalerate, ethiofencarb, ethion, ethofenprox, fenamiphos, fenazaquin, fenbutatin-oxide, fenitrothion, fenobucarb, fenothiocarb, fenoxycarb, fenpropathrin, fenpyrad, fenpyroximate, fenthion, fenvalerate, fipronil, fluazuron, flucycloxuron, flufenoxuron, flufenprox, fluvalinate, formothion, fosthiazate, fubfenprox, furathiocarb, hexaflumuron, hexythiazox, imidacloprid, isazophos, isofenphos, isoprocarb, isoxathion, ivermectin, lambda-cyhalothrin, lufenuron, mecarbam, methiocarb, methomyl, metolcarb, milbemectin, moxidectin, naled, NC 184, nitenpyram, omethoate, oxamyl, oxydemethon M, permethrin, phenthoate, phorate, phosalone, phoxim, pirimicarb, pirimiphos M, pirimiphos A, promecarb, propoxur, prothoate, pymetrozine, pyridaphenthion, pyrethrum, pyridaben, pyrimidifen, pyriproxifen, quinalphos, salithion, sebufos, silafluofen, sulfotep, suiprofos, spinosad, tebufenozide, tebufenpyrad, teflubenzuron, thiacloprid, thiafenox, thiamethoxan, thiodicarb, thiofanox, thiomethon, thionazin, triazuron, trichlorofon, triflumuron, trimethacarb, vamidothion, XMC, xylylcarb.

Examples of herbicides which may be mentioned are:

acetamiprid

benzosulfuron-methyl

cyclosulfamuron

flucarbazone

procarbazone sodium

flufenacet

diflufenican

propanil

chloridazon

norflurazon

desmedipham

phenmedipham

alachlor

acetochlor

butachlor

metazachlor

metalochlor

acifluorfen

bifenox

chlortoluron

diuron

isoproturon

linuron

dichlobenil

ioxynil

mefenacet

amidosulfuron

chlorimuron-ethyl

chlorsulfuron

cinosulfuron

methylsulfuron-methyl

nicosulfuron

primisulfuron

pyrazosulfuron-ethyl

thiofensulfuron-methyl

triasulfuron

tribenuron-methyl

atrazine

cyanazine

simazine

metamitron

metribuzin

glufosinate and

glyphosate.

Examples of plant growth regulators which may be mentioned are chlormequat-methyl and ethephon.

Oils which can be employed for carrying out the process according to the invention are all the vegetable and mineral oils which are conventionally used for the preparation of agrochemicals. Rapeseed oil, sunflower oil, soybean oil, cotton seed oil, olive oil, castor oil and white oil are preferably suitable.

Waxes which are suitable for carrying out the process according to the invention are all substances with waxy consistency which are suitable for the preparation of agrochemicals and which have a fusion point of between 80° C. and 120° C. Montan wax such as paraffin wax, polyethylene waxes with a molecular weight of up to approximately 10 000 and modified polyethylene waxes such as, for example, sulfonylated waxes, furthermore esters of montan wax acids and in some cases also hydrolyzed esters of montan wax acids can preferably be used.

Additives which are suitable for carrying out the process according to the invention are all those substances which are conventionally used as adjuvant in the preparation of agrochemicals. Carriers, for example ground natural minerals such as kaolins, clays, talc, chalk, quartz, attapulgite, montmorillonite or diatomaceous earth, or else ground synthetic rocks such as highly disperse silica, alumina and silicates, are preferably suitable.

Mixers which can be employed for carrying out the process according to the invention are all those customary mixers which are suitable for preparing wax premixes. However, a prerequisite is that the mixers can be heated and contain sharp-edged stirring devices. Preferred in this context are mixers with sharp stirring devices which have been ground to a sword-like shape or which are flattened on one side.

On carrying out the process according to the invention, high stirring speeds must be maintained. Preferably, the process is carried out at those speeds at which the outer ends of the stirring devices move at a speed of at least 18 m/sec, preferably between 18 and 40 m/sec.

When carrying out the process according to the invention, the temperatures can be varied within a certain range. In general, the process is carried out at temperatures between 10° C. and 80° C., preferably between 20° C. and 50° C.

The process according to the invention is generally carried out under atmospheric pressure. However, it is also possible to carry out the process under elevated or reduced pressure.

When carrying out the process according to the invention, both the size of the agrochemical active substance particles and the size of the wax particles can be varied within a certain range. Active substance particles with a diameter of between 20 and 180μ and wax particles with a diameter of between 4 and 150μ are preferably used.

The mixing ratios in which the individual components are employed when carrying out the process according to the invention can likewise be varied within a certain range. In general, a procedure is followed in which the following are employed per part by weight of agrochemical active substance:

1.5 to 4.0 parts by weight, preferably 1.9 to 3.0 parts by weight, of wax,

0.1 to 10 parts by weight, preferably 0.5 to 3 parts by weight, of oil and

0 to 70 parts by weight, preferably 0 to 30 parts by weight, of additives.

Specifically, a procedure is followed when carrying out the process according to the invention in which one or more solid agrochemical active substances in finely divided form are mixed, in the mixer, with at least one vegetable or mineral oil, wax in finely divided form is then added, the mixture is homogenized at high stirring speed and, if appropriate, subsequently treated with additives and again homogenized at high stirring speed. These components are preferably employed in ground form so that both wax and agrochemical active substances and also, if appropriate, additives are present in sufficiently finely divided form. If further additives are added after the agrochemical active substance particles have been coated with wax, the mixture can be charged simultaneously or successively with these additives (if there are more than one). Preferably, a procedure is followed in which a homogenization step is effected after each addition of a further component.

The wax premixes which can be prepared by the process according to the invention are finely divided free-flowing products in which the agrochemical active substance particles are enveloped in a continuous wax coat.

The wax premixes which can be prepared in accordance with the invention can be converted by a customary method to give formulations which can then be employed as agrochemicals. Thus, for example, granules which float in water can be prepared by applying, to low-density carriers, wax premixes which can be prepared in accordance with the invention, if appropriate after addition of further additives such as stickers and/or surfactants. However, products which can be prepared in accordance with the invention can also be employed directly for the treatment of plants.

The wax premixes which can be prepared in accordance with the invention and the agrochemicals which can be produced with them are distinguished by the fact that the active substances which they contain are released uniformly and over a prolonged period when the premixes/agrochemicals are employed for the treatment of plants.

The invention is illustrated by the examples which follow.

### PREPARATION EXAMPLES

### Example 1

15 parts by weight of cyclosulfamuron in the form of particles with an average diameter of 20μ and

2 parts by weight of rapeseed oil

are blended for 5 minutes at room temperature in a mixer with a sword-like stirring device.

30 parts by weight of wax (Cerridust® 5551, Clariant) in the form of particles with an average diameter of 5μ

are added at room temperature to this mixture, and everything is mixed by high-speed stirring (speed of the outer end of the stirrer at least 18 m/sec) at room temperature until a homogenous product has formed. Thereafter,

43 parts by weight of highly-disperse silica

are added and mixing is continued for 15 minutes at room temperature. 10 parts by weight of talc are subsequently added, and the mixture is stirred for a further 15 minutes at room temperature. This gives a free-flowing wax premix consisting of discrete particles with an average diameter of 70μ. Each of the active substance particles is enveloped by a continuous wax coat.

### Example 2

15 parts by weight of cyclosulfamuron in the form of particles with an average diameter of 20μ and

2 parts by weight of rapeseed oil

are blended for 5 minutes at room temperature in a mixer with a sword-like stirring device,

30 parts by weight of wax (Sanwax® 171 P, Sankyo Chem. Ind.) in the form of particles with an average diameter of 5μ

are added at room temperature to this mixture, and everything is mixed by high-speed stirring (speed of the outer end of the stirrer at least 18 m/sec) at room temperature until a homogenous product has formed. Thereafter,

43 parts by weight of highly-disperse silica

are added and mixing is continued for 15 minutes at room temperature. 10 parts by weight of talc are subsequently added, and the mixture is stirred for a further 15 minutes at room temperature. This gives a free-flowing wax premix consisting of discrete particles with an average diameter of 60μ. Each of the active substance particles is enveloped by a continuous wax coat.

### Example 3

15 parts by weight of cyclosulfamuron in the form of particles with an average diameter of 20μ and

2 parts by weight of white oil

are blended for 5 minutes at room temperature in a mixer with a sword-like stirring device.

45 parts by weight of wax (Cerridust® 5551, Clariant) in the form of particles with an average diameter of 5μ

are added at room temperature to this mixture, and everything is mixed by high-speed stirring (speed of the outer end of the stirrer at least 18 m/sec) at room temperature until a homogenous product has formed. Thereafter,

28 parts by weight of highly-disperse silica

are added and mixing is continued for 15 minutes at room temperature. 10 parts by weight of talc are subsequently added, and the mixture is stirred for a further 15 minutes at room temperature. This gives a free-flowing wax premix consisting of discrete particles with an average diameter of 60μ. Each of the active substance particles is enveloped by a continuous wax coat.

### COMPARATIVE EXAMPLES

### Example A

The procedure of example 1 is followed, except that a stirring device without sharp edges is used.

15 parts by weight of cyclosulfamuron in the form of particles of an average diameter of 20μ and

2 parts by weight of rapeseed oil

are blended for 5 minutes at room temperature in a mixer with a rounded stirring device.

30 parts by weight of wax (Cerridust® 5551, Clariant) in the form of particles with an average diameter of 5μ

are added at room temperature to this mixture, and everything is mixed by high-speed stirring (speed of the outer end of the stirrer at least 18 m/sec) at room temperature until a homogenous product has formed. Thereafter,

43 parts by weight of highly-disperse silica

are added and mixing is continued for 15 minutes at room temperature. 10 parts by weight of talc are subsequently added, and the mixture is stirred for a further 15 minutes at room temperature. This gives a wax premix consisting of agglomerated particles.

### Example B

The procedure of example 1 is followed, but no oil is used.

15 parts by weight of cyclosulfamuron in the form of particles with an average diameter of 20μ

are blended at room temperature in a mixer with a sword-like stirring device with

30 parts by weight of wax (Cerridust® 5551, Clariant) in the form of particles with an average diameter of 5μ.

The mixture is mixed by high-speed stirring (speed of the outer end of the stirrer at least 18 m/sec) at room temperature until a homogenous product has formed. Thereafter,

43 parts by weight of highly-disperse silica

are added and mixing is continued for 15 minutes at room temperature. 10 parts by weight of talc are subsequently added, and the mixture is stirred for a further 15 minutes at room temperature. This gives a wax premix consisting of active substance particles which are partly coated with wax and of separate wax particles.

### Example C

Preparation of a wax premix by the melt method.

32 parts by weight of montan wax in sheet form are heated, in a mixer, at 110° C. to give a melt. To this melt there are added

15 parts by weight of cyclosulfamuron in the form of particles with an average diameter of 5μ with stirring at 110° C. The resulting suspension is stirred at high speed for 10 minutes at 110° C. and then treated portionwise with

26.5 parts by weight of highly-disperse silica while stirring is continued at full mixer speed. The resulting flowable powder is cooled to room temperature with stirring and with addition of

26.5 parts by weight of talc.

This gives a wax premix consisting of agglomerated particles. Approximately 10 percent by weight of the cyclosulfamuron present are broken down.

1. A process for the preparation of wax premixes containing agrochemical active substances, characterized in that finely divided wax is added, in a mixer with a sharp-edged mixing device, to a finely divided mixture of
at least one solid agrochemical active substance and
at least one vegetable or mineral oil
at a high stirring speed, the temperature in the mixer being below the melting point of the wax employed, and,
if appropriate, further additives are subsequently added to the product obtained.

2. A process as claimed in claim 1, characterized in that the agrochemical active substances employed are fungicides, bactericides, insecticides, acaricides, nematicides, herbicides or plant growth regulators.

3. A method as claimed in claim 1, characterized in that rapeseed oil, sunflower oil, soybean oil, cotton seed oil, olive oil, castor oil or white oil is employed as vegetable or mineral oil.

4. A process as claimed in claim 1, characterized in that montan wax, paraffin wax, polyethylene wax or modified polyethylene wax is employed as wax component.

5. A process as claimed in claim 1, characterized in that ground natural or synthetic wax are employed as additives.

6. A process as claimed in claim 1, characterized in that temperatures between 10° C. and 80° C. are employed.
